(19) United States
(12) Patent Application Publication
(10) Pub. No.: US 2017/0112103 A1
(43) Pub. Date: Apr. 27, 2017

(54) EXPANDABLE POUCH COMBINED WITH LEASH

(71) Applicant: Walkpro LLC, Campbell, CA (US)

(72) Inventors: Christopher Iles, Campbell, CA (US); Sharon Laherran, Campbell, CA (US)

(21) Appl. No.: 14/918,760

(22) Filed: Oct. 21, 2015

(51) Int. Cl. A01K 27/00

(52) U.S. Cl. CPC A01K 27/008; A01K 27/003; A01K 27/005

(57) ABSTRACT

A leash comprises a leash body, a pouch coupled to the leash body, and an attach and transport feature configured for carrying one or more refuse bags. The pouch is expandable in order to carry keys, a wallet, a phone and other items. The attach and transport feature carries one or more used refuse bags in hands free and in a convenient location to a proper disposal.

### FIELD OF THE INVENTION

This invention generally relates to pet leashes and leash accessories. More particularly, this invention relates to a pet leash with an expandable carrying pouch and refuse bag holding system.

### BACKGROUND OF THE INVENTION

Animals provide constant companionship and enjoyment. Walking an animal provides exercise for the animal being walked as well as the person doing the walking. Particularly, by walking the animal on a leash, the animal can be walked in a safe and efficient manner. When the animal is walked however, it is necessary for the human companion to clean up after the animal. This can be an unpleasant experience as there is not a convenient place to put the refuse bag without holding it in the hand. Additionally, it is desirable to have a convenient storage compartment for holding keys, wallets, phones and other accessories needed by the animal walker.

### SUMMARY OF THE INVENTION

A leash comprises a leash body, a pouch coupled to the leash body, and an attach and transport feature configured for carrying one or more refuse bags. The pouch is expandable in order to carry keys, a wallet, a phone and other items. The attach and transport feature carries one or more used refuse bags in hands free and in a convenient location to a proper disposal.

In one aspect, a leash comprises a leash body, a pouch coupled to the leash body and an attach and transport feature configured for carrying one or more refuse bags. In some embodiments, the pouch is expandable. Particularly, the pouch is configured for carrying one or more of keys, a wallet, a phone, and other items. In some embodiments, the pouch is coupled to a handle of the leash. In further embodiments, the leash body is adjustable in order to adjust a length of the leash. Additionally, the leash can comprise a coupler configured to couple the leash body with differently sized leash ends in order to adjust a length of the leash. The attach and transport feature is configured to carry one or more used refuse bags. In some embodiments, the attach and transport feature comprise a hook and loop fastening system.

In another aspect, a leash system comprises a leash body, a pouch coupled to the leash body, an attach and transport feature configured for carrying one or more refuse bags and a coupler attached to the leash body and configured for coupling with one or more leash adjustment accessories. In some embodiments, the one or more leash adjustment accessories comprise one or more differently size leash ends. Alternatively, or in conjunction, the one or more leash adjustment accessories comprise a leash ring. In some embodiments, the coupler comprises a buckle. In some embodiments, the pouch is expandable. Particularly, the pouch is configured for carrying one or more of keys, a wallet, a phone, and other items. The attach and transport feature is configured to carry one or more used refuse bags. In some embodiments, the attach and transport feature comprise a hook and loop fastening system.

In a further aspect, a method of manufacturing a dog leash comprises manufacturing a leash body, coupling a pouch with the leash body and coupling an attach and transport feature configured for carrying one or more refuse bags with the leash body. In some embodiments, the pouch is expandable. Particularly, the pouch is configured for carrying one or more of keys, a wallet, a phone, and other items. In some embodiments, the pouch is coupled to a handle of the leash. In further embodiments, the leash body is adjustable in order to adjust a length of the leash. Additionally, the leash can comprise a coupler configured to couple the leash body with differently sized leash ends in order to adjust a length of the leash. The attach and transport feature is configured to carry one or more used refuse bags. In some embodiments, the attach and transport feature comprise a hook and loop fastening system.

### BRIEF DESCRIPTION OF THE DRAWINGS

FIG. 1 illustrates a front side view of a leash in accordance with some embodiments.

FIG. 2 illustrates a back side view of a leash in accordance with some embodiments.

FIGS. 3A-3C illustrate a leash system in accordance with some embodiments.

FIG. 4 illustrates a leash holding a used refuse bag in accordance with some embodiments.

FIG. 5 illustrates a method of manufacturing a leash in accordance with some embodiments.

### DETAILED DESCRIPTION OF THE INVENTION

Embodiments of the invention are directed to a leash comprising a leash body, a pouch coupled to the leash body, and an attach and transport feature configured for carrying one or more refuse bags. The pouch is expandable in order to carry keys, a wallet, a phone and other items. The attach and transport feature carries one or more used refuse bags in hands free and in a convenient location to a proper disposal.

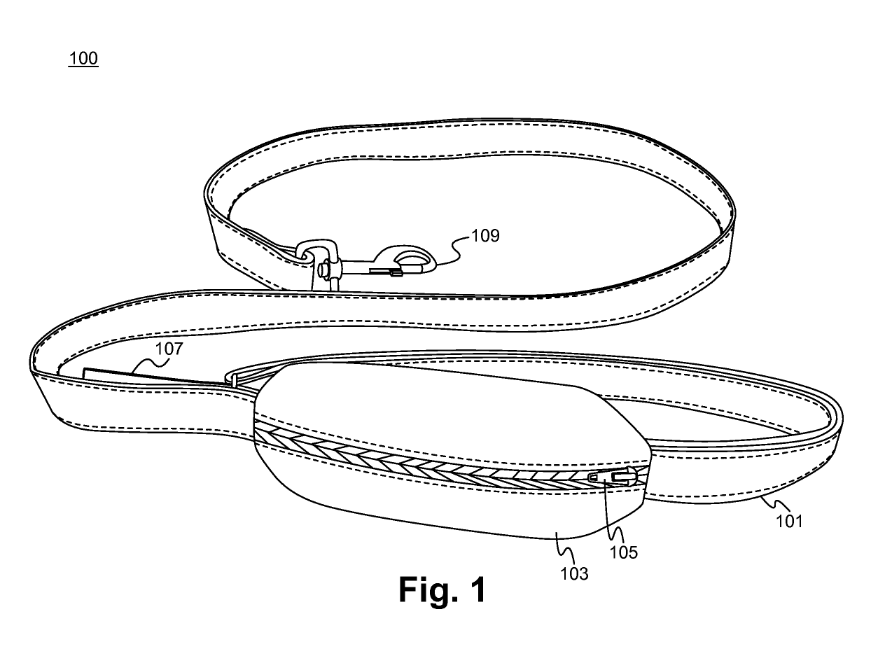

Referring now to FIG. 1, an animal leash is depicted therein. The leash 100 comprises a leash body 101, a pouch 103 coupled to the leash body 101, and an attach and transport feature 107 configured for carrying one or more refuse bags. As shown in FIG. 1, the leash comprises a clasp 109 for attaching the leash 100 to a collar or animal harness. In some embodiments, the pouch 103 is expandable. For example, in some embodiments the pouch 103 comprises an elastic, spandex or other expandable material. Particularly, the pouch 103 is configured to stretch in order to accommodate different items such as keys, a wallet, a phone and a roll of refuse bags. As further shown in FIG. 1, the pouch 103 comprises a zipper 105 for opening the pouch 103. In some embodiments, the pouch 103 is coupled to a handle of the leash 100. However, the pouch 103 is able to couple at any appropriately desired location of the leash body 101.

In some embodiments, the leash body 101 is approximately five feet in length. However, the leash body 101 can comprise any appropriately desired length. In some embodiments, the leash body 101 is adjustable. For example, in some embodiments, the leash body 101 comprises a retractable feature. As described above, the attach and transport feature 107 is configured to hold one or more refuse bags. In some embodiments, the attach and transport feature 107 comprises a hook and loop fastening system. Particularly, the attach and transport feature 107 is configured to open and close around a used refuse bag and hold the refuse bag in a convenient and sanitary location until proper disposal.

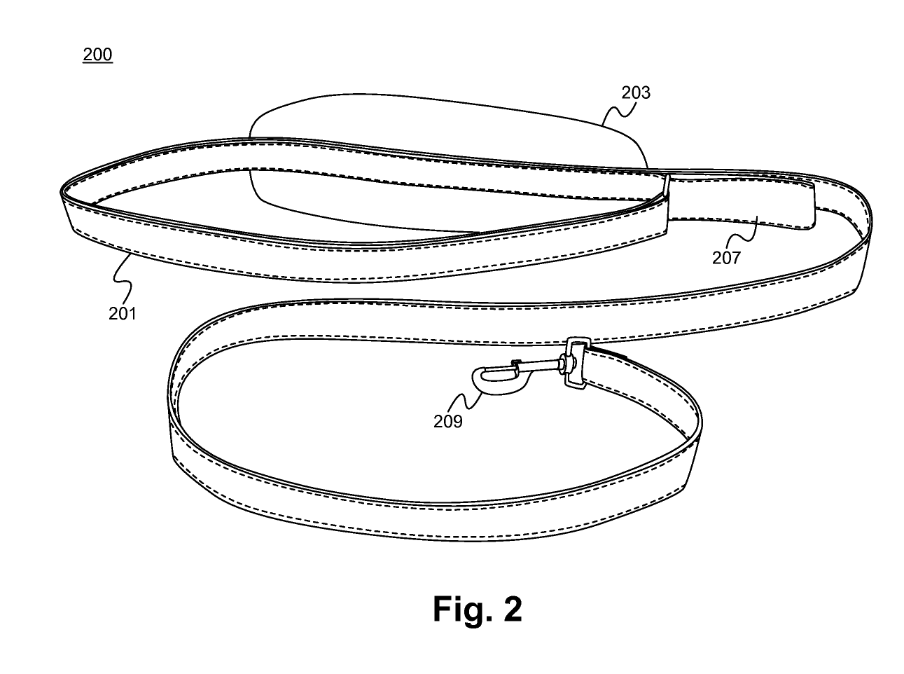

FIG. 2 illustrates a back side view of a leash such as the leash 100 described above. The leash 200 comprises a leash body 201, a pouch 203 coupled to the leash body 201, and an attach and transport feature 207 configured for carrying one or more refuse bags. As shown in FIG. 1, the leash comprises a clasp 209 for attaching the leash 200 to a collar or animal harness. In some embodiments, the pouch 203 is expandable. For example, in some embodiments the pouch 203 comprises an elastic, spandex or other expandable material. Particularly, the pouch 203 is configured to stretch in order to accommodate different items such as keys, a wallet, a phone and a roll of refuse bags.

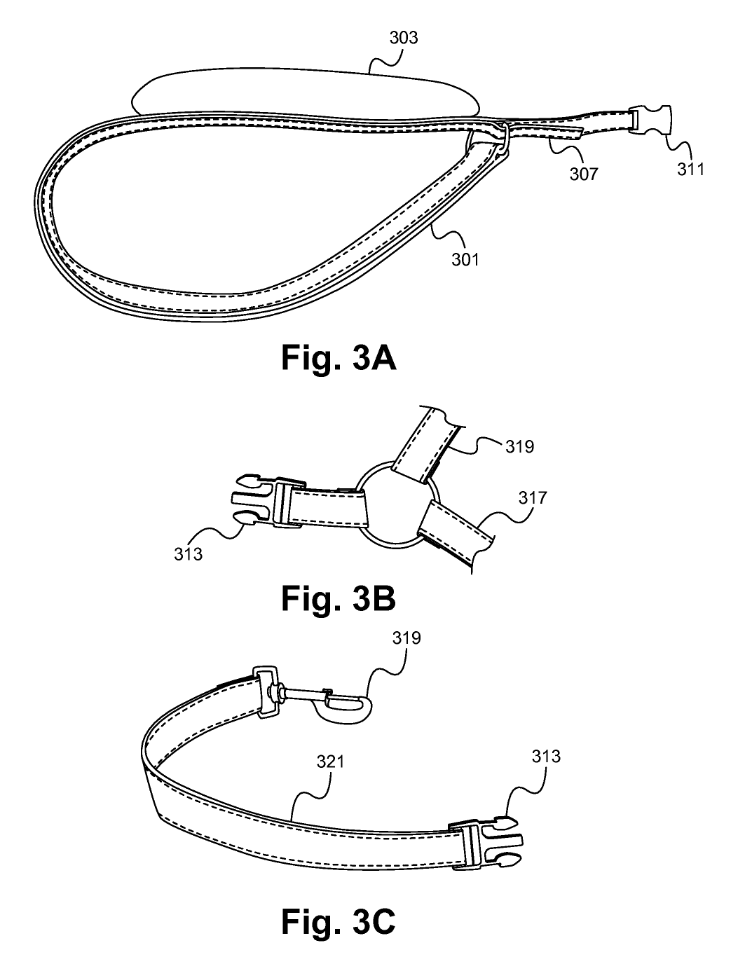

FIGS. 3A-3C illustrate a leash system in accordance with some embodiments. The leash system 300 is capable of being used with the leash 100 and the leash 200, such as described above. The system 300 comprises a leash body 301, a pouch 303 coupled to the leash body 301, an attach and transport feature 307 configured for carrying one or more refuse bags, and a coupler 311 attached to the leash body 301 and configured for coupling with one or more leash adjustment accessories. For example, in some embodiments, the one or more leash adjustment accessories comprise a leash ring 315. As shown within in FIG. 3B, the leash ring 315 comprise a first lead 317 and a second lead 319 for coupling with a first animal and a second animal, respectively in order to walk more than one animal at a time. Alternatively or in conjunction, in some embodiments, the one or more leash adjustment accessories comprises a leash end 321. Particularly, the system 300 is able to couple with one or more differently sized leash ends 321.

As shown within FIG. 3A, the coupler 311 comprises a buckle. The male buckle 311 is configured to mate with the female buckle 313 in order to couple the one or more leash adjustment accessories with the leash body 301. Although, a buckle is shown within FIGS. 3A-3C, any appropriately desired coupling mechanism may be used.

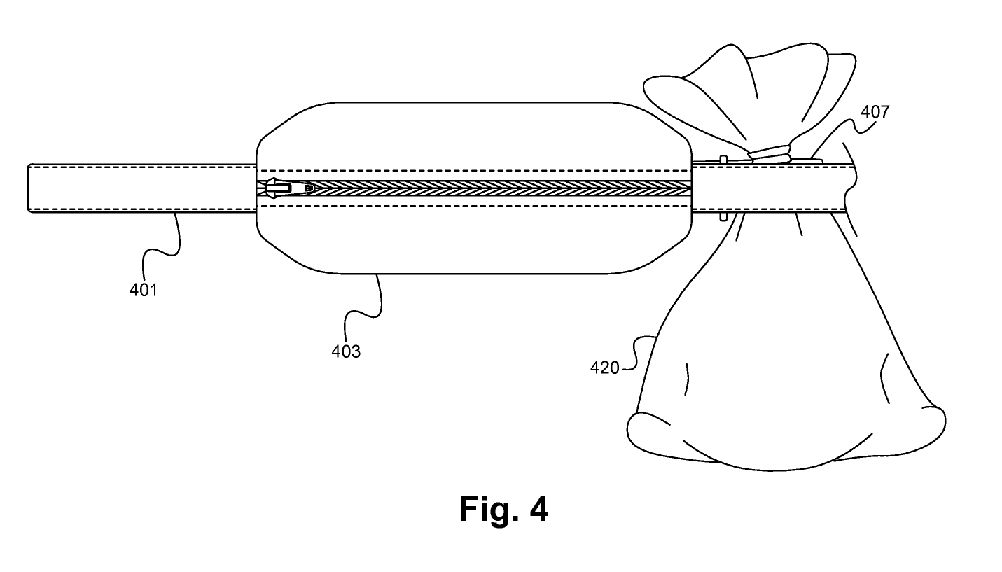

FIG. 4 illustrates a leash holding a used refuse bag in accordance with some embodiments. The leash 400 is similar to the leashes such as described above. The attach and transport feature 407 is configured one or more refuse bags. In some embodiments, the attach and transport feature 407 comprises a hook and loop fastening system. Particularly, the attach and transport feature 407 is configured to open and close around a used refuse bag and hold the refuse bag in a convenient and sanitary location until proper disposal.

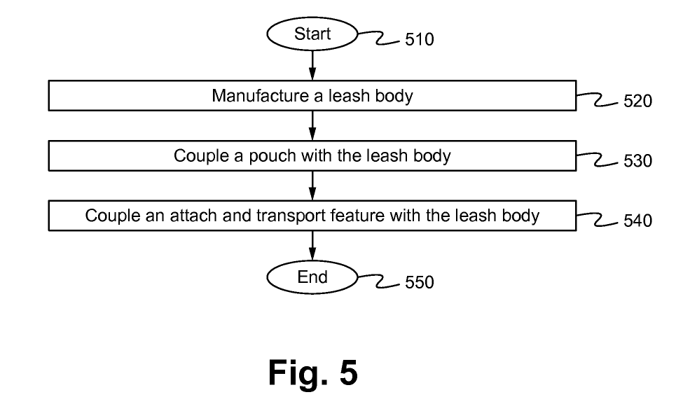

FIG. 5 illustrates a method of manufacturing a leash in accordance with some embodiments. The method begins in the step 510. In the step 520, a leash body is manufactured. In some embodiments, the leash body comprises a five foot leash. In the step 530, a pouch is coupled with the leash body. In some embodiments, the pouch is coupled with a handle of the leash body. In the step 540, an attach and transport feature for carrying one or more refuse bags is coupled with the leash body. The method ends in the step 550.

In some embodiments, the pouch is expandable and is configured for carrying one or more of keys, a wallet, and a phone. In some embodiments, the leash body is adjustable in order to adjust a length of the leash. Additionally, the leash body is able to comprise a coupler configured to couple the leash body with differently sized leash ends in order to adjust a length of the leash. The attach and transport feature is configured to carry one or more used refuse bags. In some embodiments, the attach and transport feature comprise a hook and loop fastening system.

In operation, a person is able to walk one or more animals using a leash comprising a leash body, an expandable pouch and an attach and transport feature. Particularly, the person is able to put one or more of their keys, wallet, phone, and refuse into the expandable pouch to keep the items in a close and convenient location while walking the one or more animals. Additionally, because the pouch is expandable it is able to be stretched in order to accommodate additional items. Further, when the one or more animals need to use the bathroom, the refuse bag is easily attached to and secured by the attach and transport mechanism. Consequently, the soiled refuse bag is secured in a sanitary manner until it can be properly disposed of. Accordingly, the present invention as described herein has many advantages.

The present invention has been described in terms of specific embodiments incorporating details to facilitate the understanding of the principles of construction and operation of the invention. Such references, herein, to specific embodiments and details thereof are not intended to limit the scope of the claims appended hereto. It will be apparent to those skilled in the art that modifications can be made in the embodiments chosen for illustration without departing from the spirit and scope of the invention.

We claim:

1. A leash comprising:
a. a leash body;
b. a pouch coupled to the leash body; and
c. an attach and transport feature configured for carrying one or more refuse bags.

2. The leash of claim 1 wherein the pouch is expandable.

3. The leash of claim 1 wherein the pouch is configured for carrying one or more of keys, a wallet, and a phone.

4. The leash of claim 1 wherein the pouch is coupled to a handle of the leash.

5. The leash of claim 1 wherein the leash body is adjustable in order to adjust a length of the leash.

6. The leash of claim 5 wherein the leash boy comprises a coupler configured to couple the leash body with differently sized leash ends in order to adjust a length of the leash.

7. The leash of claim 1 wherein the attach and transport feature is configured to carry one or more used refuse bags.

8. The leash of claim 1 wherein the attach and transport feature comprise a hook and loop fastening system.

9. A leash system comprising:
a. a leash body;
b. a pouch coupled to the leash body;
c. an attach and transport feature configured for carrying one or more refuse bags; and
d. a coupler attached to the leash body and configured for coupling with one or more leash adjustment accessories.

10. The leash system of claim 9 wherein the one or more leash adjustment accessories comprise one or more differently size leash ends.

11. The leash system of claim 9 wherein the one or more leash adjustment accessories comprise a leash ring.

12. The leash system of claim 9 wherein the coupler comprises a buckle.

13. The leash system of claim 9 wherein the pouch is expandable.

14. The leash system of claim 9 wherein the pouch is configured for carrying one or more of keys, a wallet, and a phone.

15. The leash system of claim 9 wherein the attach and transport feature is configured to carry one or more used refuse bags.

16. The leash system of claim 9 wherein the attach and transport feature comprise a hook and loop fastening system.

17. A method of manufacturing a dog leash comprising:
a. manufacturing a leash body;
b. coupling a pouch with the leash body; and
c. coupling an attach and transport feature configured for carrying one or more refuse bags with the leash body.

18. The method of claim 17 wherein the pouch is expandable.

19. The method of claim 17 wherein the pouch is configured for carrying one or more of keys, a wallet, and a phone.

20. The method of claim 17 wherein the pouch is coupled to a handle of the leash.

21. The method of claim 17 wherein the leash body is adjustable in order to adjust a length of the leash.

22. The method of claim 21 wherein the leash boy comprises a coupler configured to couple the leash body with differently sized leash ends in order to adjust a length of the leash.

23. The method of claim 17 wherein the attach and transport feature is configured to carry one or more used refuse bags.

24. The method of claim 17 wherein the attach and transport feature comprise a hook and loop fastening system.
